(19) United States
(12) Patent Application Publication
(10) Pub. No.: US 2026/0172993 A1
(43) Pub. Date: Jun. 18, 2026

(54) CHIRP LINK SYNCHRONIZATION FOR THE 802.3DM STANDARD AMENDMENT

(71) Applicant: Marvell Asia Pte Ltd, Singapore (SG)

(72) Inventors: Aleksei Zherebtsov, Karlsruhe (DE); Frank J. McCarthy, Alameda, CA (US)

(21) Appl. No.: 19/422,965

(22) Filed: Dec. 17, 2025

Related U.S. Application Data
(60) Provisional application No. 63/735,045, filed on Dec. 17, 2024.

(51) Int. Cl. H04W 56/00; H04W 84/20

(52) U.S. Cl. CPC H04W 56/00; H04W 84/20

(57) ABSTRACT

A method of Link Synchronization (LS) signal generation is robust to the presence of the clock frequency offset and is used to enable LS function in crystal-less mode of operation. In the method of LS signal generation, the binary chirp (linearly frequency modulated) signal is used.

### CROSS-REFERENCE TO RELATED APPLICATION(S)

This application claims the benefit of U.S. Provisional Patent Application Ser. No. 63/735,045, filed Dec. 17, 2024, and titled “CHIRP LINK SYNCHRONIZATION FOR THE 802.3DM STANDARD AMENDMENT,” which is hereby incorporated by reference in its entirety for all purposes.

### FIELD OF THE INVENTION

The present invention relates to networking. More specifically, the present invention relates to link synchronization.

### BACKGROUND OF THE INVENTION

According to the 802.3ch standard amendment (section 149.1.3.4 Link Synchronization), “The Link Synchronization function is used when Auto-Negotiation is disabled or not implemented to detect the presence of the link partner, time and control link failure, and act as the data source for the PHY control state diagram. Link Synchronization (LS) operates in a half-duplex fashion. LS is defined in 149.4.2.6.” In the 802.3ch standard amendment the LS signal (LSS) is PAM-2 signal modulated by PN sequence.

The developed 802.3dm standard amendment also shall have the LS function defined. The developed 802.3dm standard amendment shall support crystal-less operation of the PHY which is configured as SLAVE (e.g., to receive/follow timing from a MASTER's signal). One of the features of the crystal-less operation is the presence of the random clock rate offset (CFO) of the SLAVE PHY clock during LS. The CFO is the deviation of an oscillator's frequency from its ideal or target frequency. The CFO could have a random value from 0 to −20% from the nominal value.

For the worst-case SLAVE PHY CFO equal to 20%, the LS signal received at the SLAVE PHY side has CFO-20%, and the LS signal received at the MASTER PHY side has CFO+25%.

The problem is that the presence of the random CFO within the range from −20% to 25% significantly degrades performance of the Link Synchronization Signal Detectors (the probability of the missed detection Pmd in these conditions could reach prohibitively high value).

In the 802.3ch standard amendment, the Link Synchronization signal is a PAM-2 signal modulated by PN m-sequence with the order of polynomial P=8, and the period of the m sequence N=255 bits.

If the PHY is configured as MASTER, the following polynomial is used:

$$pM ( x ) = x 8 + x 4 + x 3 + x 2 + 1$$

If the PHY is configured as SLAVE, the following polynomial is used:

$$pM ( x ) = x 8 + x 6 + x 5 + x 4 + 1$$

The waveform of the LS signal at the ADC output is shown in FIG. 1, where SNR is 0 dB.

The common approach to detect the LS signal is to use the LS signal detector (LSSD) which is based on the matched filter (MF). The MF impulse response (IR) could be matched to one or several periods of LS signal PRBS.

For example, the detector input signal could be filtered by a 510 taps FIR filter which is matched to one period of the LS signal pseudo-random binary sequence (PRBS) defined in the 802.3ch standard amendment (assuming to use 2 LSSD MF IR taps per 1 symbol of PRBS).

A block diagram for Link Synchronization Signal Detector is shown in FIG. 2.

An example of the LS signal at the LSSD MF output is shown in the FIG. 3, where SNR=0 dB.

Unfortunately, this LS signal detector is very sensitive to the clock rate offset, which in crystal-less operation could vary in the range from −20% to +25% (−2e5 ppm to +2.5e5 ppm).

The dependence of the maximum absolute value of the LSSD MF output from the clock rate offset is shown in the FIG. 4.

It is clearly visible from the graph in the FIG. 4, that the LSSD MF response max value is below threshold for the CFO value larger than about 1%. The main reason for this kind of sensitivity is that the actual Baud rate of the LS signal is changing proportionally to the clock rate. If the Baud rate of the received LS is changed considerably from the expected Baud rate, then the correlation between received LS signal and LSSD MF IR decreases below the threshold. In result, a missed detection event could occur.

### SUMMARY OF THE INVENTION

A method of Link Synchronization (LS) signal generation is robust to the presence of the clock frequency offset and is used to enable LS function in crystal-less mode of operation. In the method of LS signal generation, the binary chirp (linearly frequency modulated) signal is used.

In one aspect, a method comprises generating a link synchronization signal, wherein the link synchronization signal comprises a binary chirp signal and detecting the link synchronization signal in a crystal-less mode of operation. The link synchronization signal is generated using a link synchronization signal generator, and the link synchronization signal is detected using a link synchronization signal detector. The link synchronization signal generator comprises a plurality of counters. The plurality of counters comprise an output sample counter, an output period counter, a phase increment counter, and a phase counter. The binary chirp signal is based on a plurality of counters. The binary chirp signal is defined based on a sign of a sinusoidal chirp signal. Generating the link synchronization signal involves wrapping values using rules of two's complement arithmetic. Generating the link synchronization signal involves scaling parameters so that all values are integers.

In another aspect, an apparatus comprises a link synchronization signal generator configured for generating a link synchronization signal, wherein the link synchronization signal comprises a binary chirp signal and sending the link synchronization signal to a link synchronization signal detector in a crystal-less mode of operation. The link synchronization signal is generated using a link synchronization signal generator, and the link synchronization signal is detected using a link synchronization signal detector. The link synchronization signal generator comprises a plurality of counters. The plurality of counters comprise an output sample counter, an output period counter, a phase increment counter, and a phase counter. The binary chirp signal is based on a plurality of counters. The binary chirp signal is defined based on a sign of a sinusoidal chirp signal. Generating the link synchronization signal involves wrapping values using rules of two's complement arithmetic. Generating the link synchronization signal involves scaling parameters so that all values are integers.

In another aspect, a system comprises a link synchronization signal generator configured for generating a link synchronization signal, wherein the link synchronization signal comprises a binary chirp signal and a link synchronization signal detector configured for detecting the link synchronization signal in a crystal-less mode of operation. The link synchronization signal is generated using a link synchronization signal generator, and the link synchronization signal is detected using a link synchronization signal detector. The link synchronization signal generator comprises a plurality of counters. The plurality of counters comprise an output sample counter, an output period counter, a phase increment counter, and a phase counter. The binary chirp signal is based on a plurality of counters. The binary chirp signal is defined based on a sign of a sinusoidal chirp signal. Generating the link synchronization signal involves wrapping values using rules of two's complement arithmetic. Generating the link synchronization signal involves scaling parameters so that all values are integers.

### BRIEF DESCRIPTION OF THE DRAWINGS

FIG. 1 shows an LS signal waveform.

FIG. 2 shows an LSSD block diagram.

FIG. 3 shows LSSD MF response to the LS signal PRBS.

FIG. 4 shows LSSD sensitivity to CFO.

FIG. 5 shows the sinusoidal chirp signal waveform according to some embodiments.

FIG. 6 shows the binary and sinusoidal chirp signal waveforms according to some embodiments.

FIG. 7 shows the comparison of the sine chirp phase φ(t (n)) and binary chirp phase p(n) according to some embodiments.

FIG. 8 shows the binary chirp phase p(n) wrapped by the rules of the two's complement arithmetic according to some embodiments.

FIG. 9 shows the time diagram of the phase counter p(n) according to some embodiments.

FIG. 10 shows the LS signal generator (LSSG) output s(n) and phase signal p(n) scaled by 524288 according to some embodiments.

FIG. 11 shows the LSSG block diagram according to some embodiments.

FIG. 12 shows the probability of the LS signal detection P_{d} versus AWGN channel SNR value according to some embodiments.

FIG. 13 shows a block diagram of an exemplary computing device configured to implement the LS signal generation method according to some embodiments.

FIG. 14 shows a flowchart of an LS signal generation method according to some embodiments.

FIG. 15 shows a block diagram of a Link Synchronization Signal Generator (LSSG) and a Link Synchronization Signal Detector (LSSD) according to some embodiments.

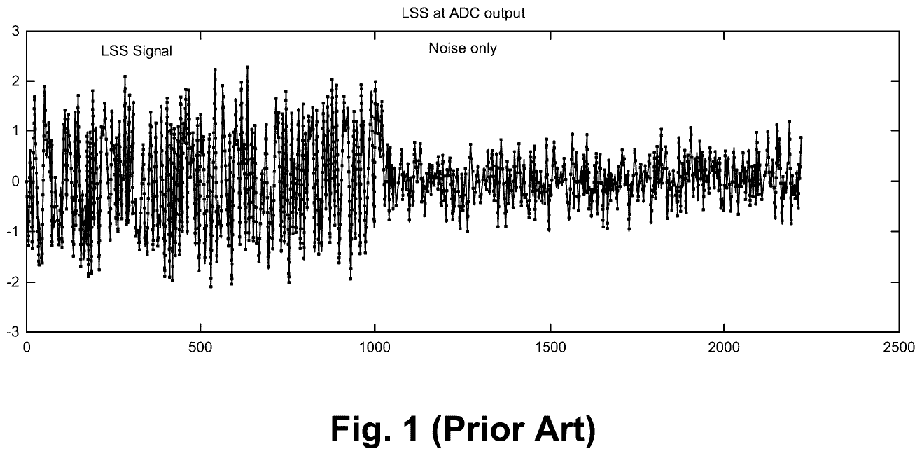

### DETAILED DESCRIPTION OF THE PREFERRED EMBODIMENT

A method for Link Synchronization Signal (LSS) generation, which is robust to the presence of the clock frequency offset, is used to enable the Link Synchronization (LS) function in crystal-less mode of operation.

In the method for LS signal generation, the binary chirp (linearly frequency modulated) signal is used.

The binary chirp signal is a linearly frequency modulated signal which uses a square wave instead of a sine wave as a carrier. The binary chirp signal is defined based on the sign of the sinusoidal chirp signal. The frequency of the sinusoidal chirp signal changes linearly over the specified frequency range. The sinusoidal chirp signal parameters are defined as follows.

F1 and F2 are starting and final chirp frequencies for the LSS (in Hz).
Fs=1.40625 GHz is the sample rate for the LSS:

$${F}_{s} = \{ \begin{matrix}( 11.25 GHz ) / 2 = 5.625 GHz & for 10 Gbps mode \\ ( 11.25 GHz ) / 4 = 2.8125 GHz & for 5 Gbps mode \\ ( 11.25 GHz ) / 8 = 1.40625 GHz & for 2.5 Gbps mode\end{matrix}$$

T is the duration of the chirp signal in seconds:

$$T = N / {F}_{s}$$

N is the number of samples in one period of the chirp signal, which depends on the High Data Rate (HDR) baud rate as follows:

$$N = T * {F}_{s} = \{ \begin{matrix}2048 & for 10 Gbps mode \\ 1024 & for 5 Gbps mode \\ 512 & for 2.5 Gbps mode\end{matrix}$$

R is the integer-valued ratio of the starting and final frequencies:

$${F}_{1} = {F}_{ref} / 24 as currently proposed$$

$${F}_{2} = R * {F}_{1} = R * {F}_{ref} / 24 = {F}_{ref} / 6$$

where Fref=11.25/8 GHZ=1.40625 GHz and R=4
Δ is the constant rate of change for the frequency of the LSS chirp signal. This is also called the chirp rate:

$$Δ = ( {F}_{2} - {F}_{1} ) / T$$

t is the time in seconds:

$$t = k / {F}_{2} , where 0 \leq t < T , and 0 \leq k < N$$

Finally, Nₚ is the number of periods in the chirp signal. The instantaneous frequency f(t) of the LSS chirp is:

$$\begin{matrix}f ( t ) = f ( k / {F}_{2} ) = {F}_{1} + Δ * t \\ = {F}_{1} + \frac{{F}_{2} - {F}_{1}}{T} * t\end{matrix}$$

Recalling that phase is the integral of frequency; then the sinusoidal chirp signal is:

$$y ( t ) = sin ( 2 π * ( {F}_{1} * t + 0.5 * \frac{{F}_{2} - {F}_{1}}{T} * {t}^{2} ) ) ,$$

$$Substituting ( k / {F}_{2} ) for t and changing to time index k$$

$$\begin{matrix}y ( k ) = sin ( 2 π * ( {F}_{1} * ( k / {F}_{2} ) + 0.5 * \frac{{F}_{2} - {F}_{1}}{T} * {( k / {F}_{2} )}^{2} ) ) , \\ = sin ( 2 π * ( \frac{{F}_{1}}{{F}_{2}} * k + 0.5 * \frac{{F}_{2} - {F}_{1}}{{F}_{2}} * \frac{{k}^{2}}{T * {F}_{2}} ) ) , \\ = sin ( 2 π * ( \frac{{F}_{1}}{{F}_{2}} * k + 0.5 * \frac{{F}_{2} - {F}_{1}}{{F}_{2}} * \frac{{k}^{2}}{N} ) ) ,\end{matrix}$$

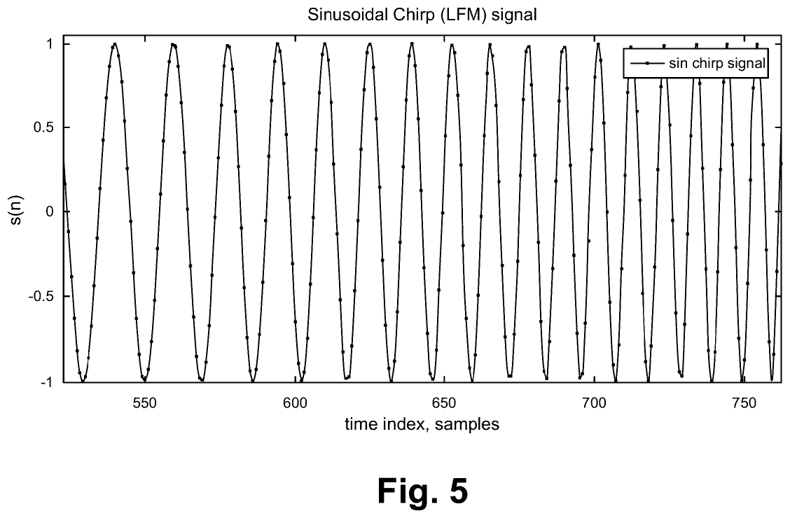

A sample sinusoidal chirp signal waveform is shown in FIG. 5.

The sign function is defined as:

$$sign ( x ) = \{ \begin{matrix}+ 1 & for 0 \leq x \\ - 1 & for x < 0\end{matrix}$$

Using the definition of the sinusoidal chirp signal and the definition of the sign function, the binary chirp signal is:

$$s ( t * {F}_{2} ) = s ( k ) = sign ( y ( k ) ) = \{ \begin{matrix}+ 1 & for y ( k ) \geq 0 \\ - 1 & Otherwise\end{matrix}$$

The phase function for the chirp signal is:

$$y ( t * {F}_{2} ) = y ( k ) = sin ( ϕ ( k ) ) , and$$

$$ϕ ( k ) = 2 π * ( \frac{{F}_{1}}{{F}_{2}} * k + 0.5 * \frac{{F}_{2} - {F}_{1}}{{F}_{2}} * \frac{{k}^{2}}{N} ) mod 2 π$$

where k=0, 1, 2, . . .

Using given definitions and the properties of the sine function, the binary chirp signal becomes:

$$s ( k ) = \{ \begin{matrix}+ 1 & for 0 \leq ϕ ( k ) < π \\ - 1 & otherwise\end{matrix}$$

After removing π from the equation for s(k), the binary chirp signal becomes:

$$s ( k ) = \{ \begin{matrix}+ 1 & for 0 \leq ( \frac{ϕ ( k )}{π} ) < 1. \\ - 1 & otherwise\end{matrix}$$

$$or$$

$$s ( k ) = \{ \begin{matrix}+ 1 & for 0 \leq 2 * ( \frac{{F}_{1}}{{F}_{2}} * k + 0.5 * \frac{{F}_{2} - {F}_{1}}{{F}_{2}} * \frac{{k}^{2}}{N} ) < 1. \\ - 1 & otherwise\end{matrix}$$

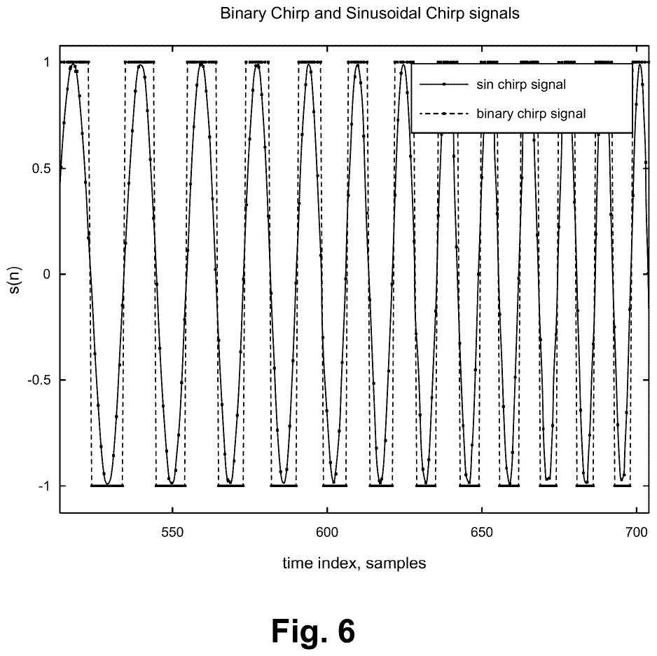

The binary chirp signal waveform together with the original sinusoidal chirp signal waveform are shown in FIG. 6.

The straight-forward implementation of the provided definition of the binary chirp signal is computationally intensive and implements the several multipliers and sine function.

It is possible to derive a much simpler implementation of the binary chirp signal generator using the following parameters:

1. The output value of the binary chirp is completely defined by the current phase of the sine function in the y(n) definition.

If the current phase φ(t) is in the range [−π,0) then the binary chirp signal has value −1.

If the current phase φ(t) is in the range [0,π] then the binary chirp signal has value 1.

This relation is captured by the following equation:

$$s ( φ ( t ) ) = - 1 if - π <= φ ( t ) < 0$$

$$s ( φ ( t ) ) = - 1 if 0 <= φ ( t ) < π$$

2. The phase of the sinusoidal chirp signal y(t) is growing with phase step which in turn is growing linearly with the constant step defined by the chirp rate.

The definition of the phase of the sinusoidal chirp signal φ(t) is given below:

$$φ\_rad ( t ) = 2 * π * ( F 1 * t + 0.5 * Delta * t . \hat{} 2 )$$

and for the time defined in samples instead of seconds:

$$φ\_rad ( k ) = 2 * π * ( F 1 * k / Fs + 0.5 * Delta * ( k / Fs ) . \hat{} 2 )$$

To avoid operations with irrational number x, the phase signal φ(n) is scaled by x:

$$φ ( k ) = φ\_rad ( k ) / π = 2 * ( F 1 * k / Fs + 0.5 * Delta * ( k / Fs ) . \hat{} 2 )$$

The φ(k) definition could be replaced by the simple discrete version of the phase signal p(n).

$$p ( n ) = p ( n - 1 ) + r ( n )$$

where r(n) is the phase increment signal:

$$r ( n ) = r ( n - 1 ) + p2\_float$$

where p2_float is the rate of change of the phase increment:

$$p 2 \_float = 2 * f\_inc / Fs$$

and f_inc is the chirp rate per 1 sample:

$$f\_inc = ( F 2 - F 1 ) / N$$

N is the number of samples to generate:

$$N = T * Fs$$

where T is chirp signal duration, Fs is the sampling frequency.

The initial phase increment is defined by the starting frequency F1 and the rate of change of the phase increment p2:

$$r ( 0 ) = r0\_float = 2 * F 1 / Fs + p2\_float / 2 ;$$

The initial phase could be set to 0:

$$p ( 0 ) = 0$$

The output signal s(n) in this case is defined as:

$$s ( n ) = sign ( sin ( π * p ( n ) ) )$$

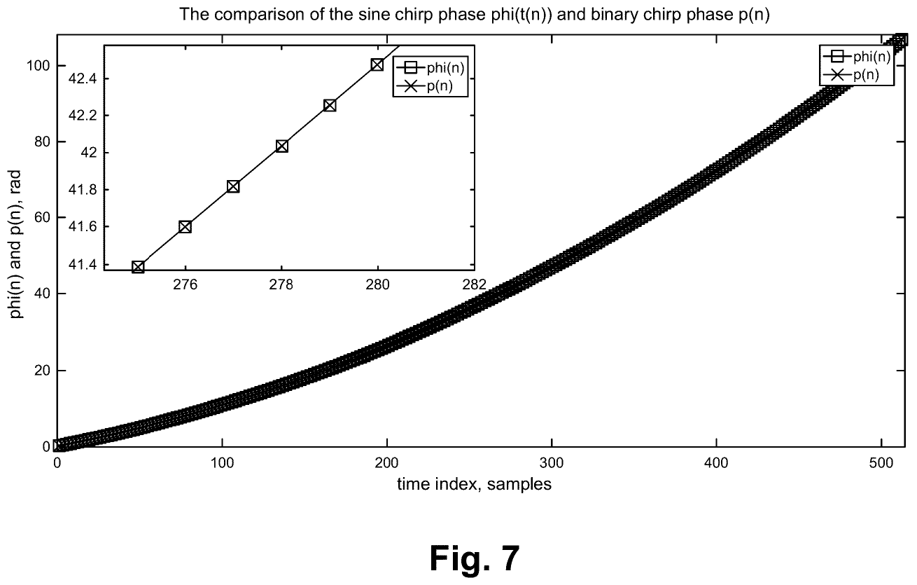

The comparison of the phase signals φ(n) and p(n) is shown in the FIG. 7.

It is shown that the simpler definition of the phase signal p(n) could be used instead of the initial phase signal φ(n) providing the same results (within the range of the floating-point error).

The definition of the phase signal p(n) is simpler to implement than φ(n), but some additional simplifications are still possible.

First, it is growing without limit and still uses the sine function to define the signal sign from the infinitely growing phase.

This problem is solved by wrapping the p(n) values using rules of the two's complement arithmetic. Therefore, when a value exceeds the maximum positive value, the value wraps around to the most negative value. Similarly, when a value goes below the most negative value, the value wraps around to the maximum positive value.

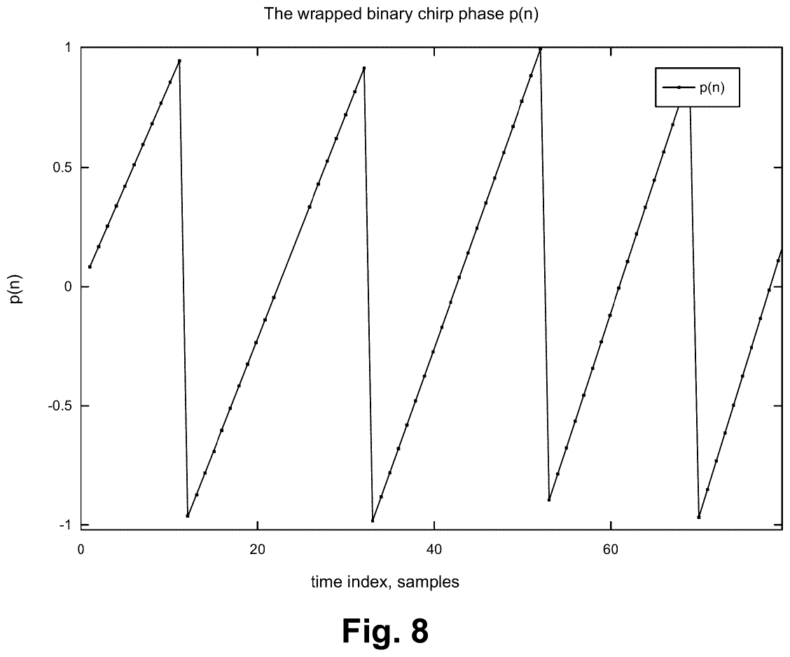

The wrapped phase waveform is shown in the FIG. 8.

Additional benefit from the wrapped implementation is that for this case the output signal could be defined just by the sign of the phase signal p(n):

$$s ( n ) = sign ( p ( n ) )$$

All chirp generator parameters are able to be scaled in such a way so that all values will be integers. The smallest value defining the p(n) is the rate of change of the phase increment p2_float. If it is scaled to have the integer value, then all other values also could be scaled using the same scale factor. The chirp signal parameters are able to be chosen in such a way so that p2_float will be equal to some number:

$$lsb = 2 \hat{} - ( len\_fxp - 1 )$$

For example, for the following values of the chirp signal parameters:

$$F 1 = 703.125 * 2 / 24 = 58.59375 MHz$$

$$F 2 = 4 * F 1 = 234.3 \; 75 MHz$$

T=N/Fs=2048/(5625e6)=3.6408e-07 seconds, where:
N=2048—the length of the LSS in samples at the 5625 MHz sampling rate.

The frequency increment of the chirp signal has the value:

$$f\_inc = ( F 2 - F 1 ) / N = ( 234.3 \; 75 e 6 - 58.59375 e 6 ) / 2048 = 85830.6 \; 884765625 Hz$$

The floating-point value of the increment of the phase increment counter then is:

$$p2\_float = 2 * f\_inc / Fs = 2 * 85830. 6884765 \; 625 / 5625 e 6 = 3.0517578125 e - 05 = 2 \hat{} - 15$$

Fixed-point format (16,0) with binary word length len_fxp=16 and two's complement signed integers are used to represent signals p(n) and r(n) for all variants of the binary chirp signal.

To have greater flexibility in the initial values of phase increment and phase counters, the binary word length len_fxp=20 and fixed-point format (20,0) could be used.

The floating-point value of the initial value of the phase increment counter:

$$r 0 \_float = 2 * F 1 / fs + p2\_float / 2 = 2 * 58.59375 e 6 / 5625 e 6 + 3.0517578125 e - 05 / 2 = 0.02084859212239583$$

In an example, the p2_float at sampling frequency 5625 MHz has the smallest value among all parameters of the binary chirp signal. Then, for integer implementation with binary word length len_fxp=20, phase values are scaled by the least significant bit, lsb=2\hat{ }−19. Then the fixed-point value of the increment of the phase increment counter:

$$p 2 = round ( p2\_float / 2 \hat{} - ( len\_fxp - 1 ) ) = round ( 3.0517578125 e - 05 / 1.9073 e - 06 ) = 16$$

And the fixed-point value of the initial value of the phase increment counter:

$$r ( 0 ) = r 0 = round ( r0\_float / 2 \hat{} - ( len\_fxp - 1 ) ) = round ( 0.02084859212239583 / 1.9073 e - 06 ) = 10931$$

The final version of the integer phase signal is defined by the following equations:

$$p ( n ) = p ( n - 1 ) + r ( n )$$

$$r ( n ) = r ( n - 1 ) + p 2$$

$$r ( 0 ) = r 0$$

$$p ( 0 ) = 0$$

The output signal s(n) is defined as sign of p(n) earlier.

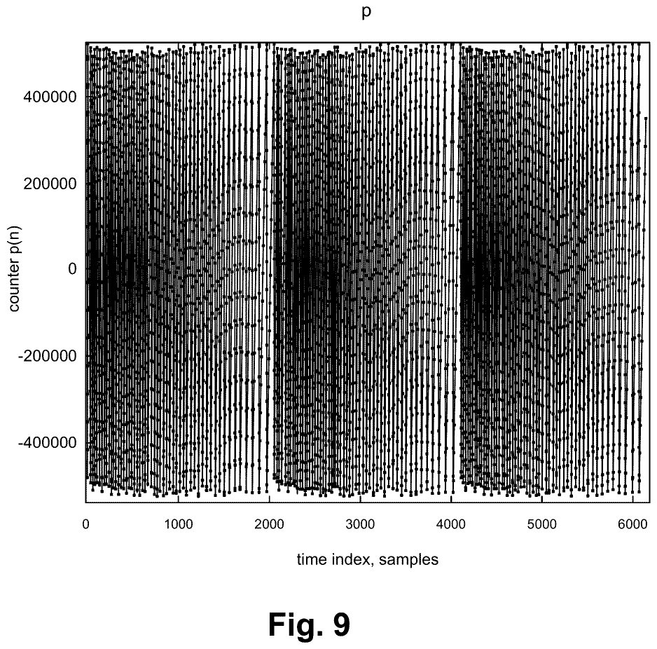

When using this format (20,0) the phase signal p(n) will change in range [−524288, 524287]. The waveform of the p(n) is shown in the FIG. 9.

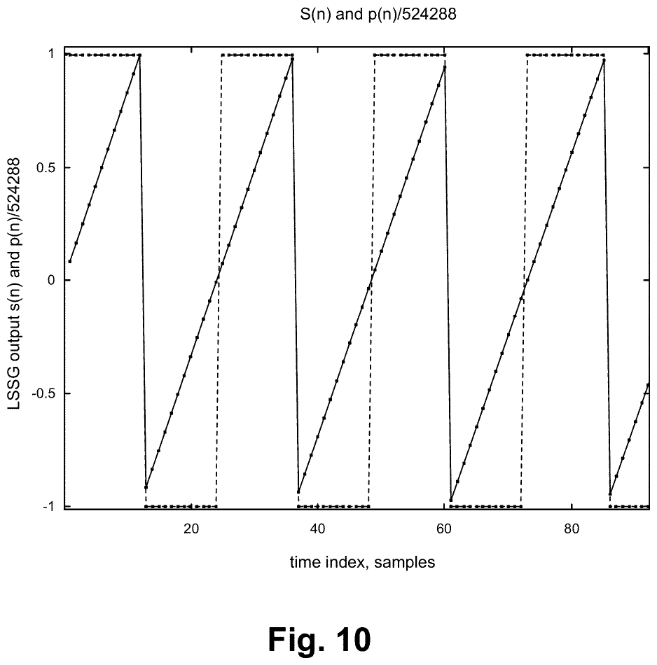

The output signal s(n) and the scaled phase p(n)/524288 is shown in the FIG. 10.

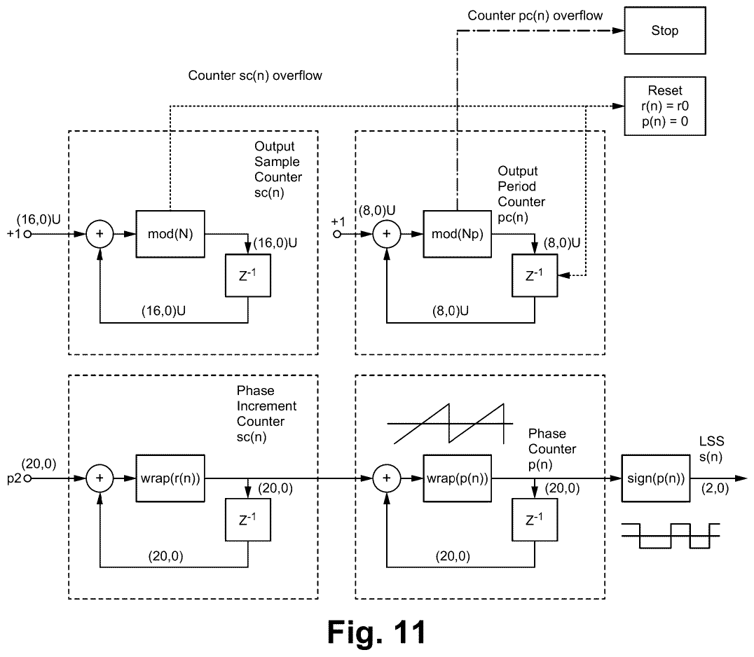

The LSSG block diagram is shown in the FIG. 11. In some embodiments, the LSSG includes multiple counters such as an output sample counter, an output period counter, a phase increment counter, and a phase counter. The counters implement the LSS generation method as described herein.

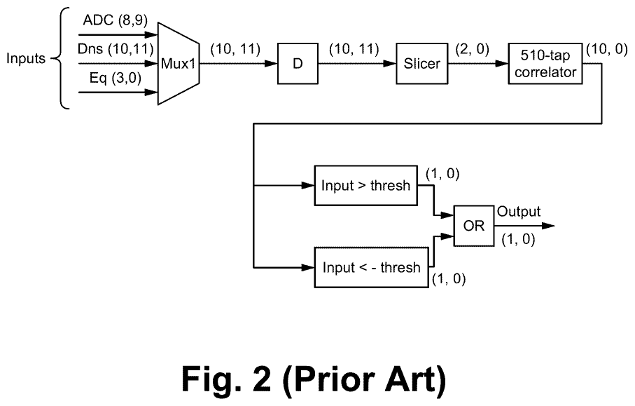

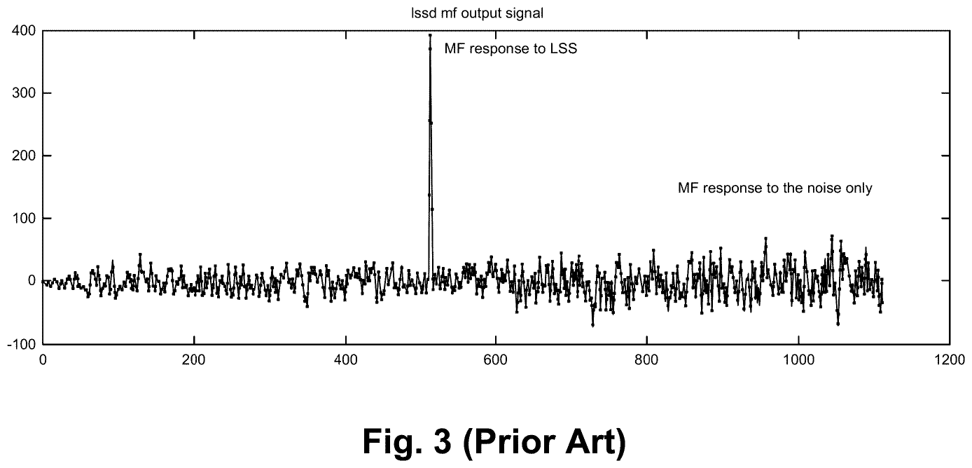

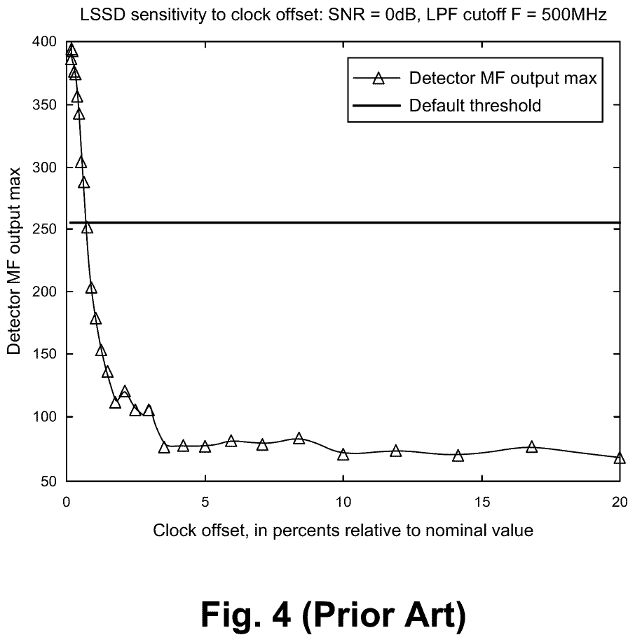

The LS signal detector (LSSD) could be implemented as matched filter (the LSSD block diagram is shown in the FIG. 2).

To compare the performance of the 802.3ch PRBS LS signal detection and chirp LS signal, the simulations to estimate the probability of the LS signal detection P_{d} versus signal to noise ratio (SNR) of the additive white gaussian noise (AWGN) channel were done. The simulations were done for 3 different values of the CFO: −20%, 0% and 25%. The probability of the False Alarm P_{FA} was fixed at 1e-2 by setting appropriate LSSD threshold.

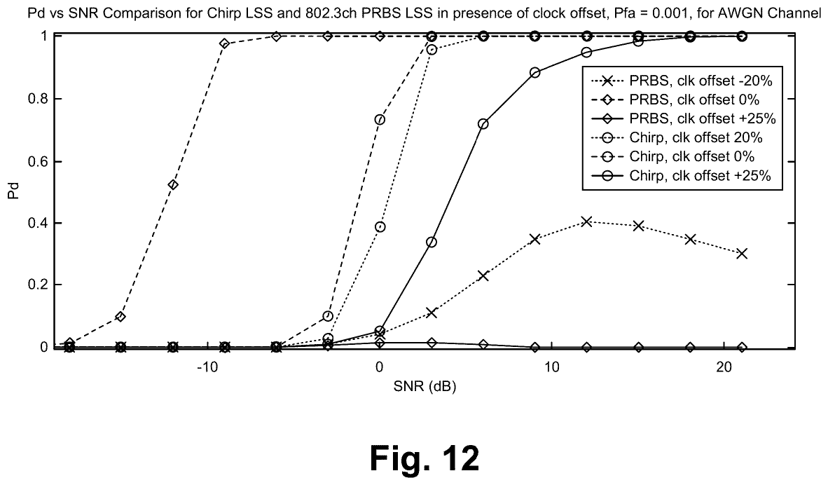

The P_{d}(SNR) plots are shown in the FIG. 12.

For the CFO equal to 25% PRBS LSSD P_{d} is below 0.04 for any SNR value, therefore PRBS LS signal cannot be reliably detected for this CFO value.

For the CFO equal to −20% PRBS LSSD P_{d} is below 0.4 for any SNR value, therefore PRBS LS signal cannot be reliably detected for this CFO value.

At the same time the Chirp LSSD P_{d} is higher than 0.96 for any SNR higher than 12 dB for any CFO value in the specified range from −20% to 25%. This observation demonstrates that the chirp LSSG and LSSD are robust to the presence of the CFO in the specified range from −20% to 25%.

Therefore, chirp LSSG and LSSD can be used as the solution of the stated problem which enables link synchronization function in the presence of the CFO in a crystal-less mode of operation.

At the beginning of a communication (e.g., in a vehicle camera system), the link synchronization procedure is performed where both link partners send an LSS to each other and indicate to each other their presence and to start a training procedure. In a simplified camera model, with the stable clock frequency generator removed, the problem was that the previous LSS was not detectable anymore. However, with the LSS described herein, which is a binary chirp, the LSS is able to be detected even without the stable clock frequency generator.

The frequency inside of this signal is linearly changing in time. It starts from some slow frequency, such as a 50 megahertz square wave, and then as time passes by, the period of the square wave shrinks linearly in time. By the end of the signal generation, it could be 200 megahertz. Then in the detector, a pattern is matched to the middle of the signal. If the signal is frequency translated due to the clock frequency offset, it is frequency translated either to the lower frequency range or the higher frequency range. Without the clock frequency offset, the signal has a pattern which is from 50 to 200 megahertz. After frequency offset, it is from 80 megahertz to 170 megahertz, approximately. The part in the middle of the signal is still matched to what is stored in the detector-matched filter. Thus, due to the random clock frequency offset, the signal is shifted left and right in frequency domain. The detector expects the middle part of the signal. Therefore, it does not matter in this given range from minus 20% to plus 25%. The portion in the middle, which is stored in the detector, will always be present in the signal, even after clock frequency offset with random value in this defined range.

Although exemplary data (e.g., frequencies), implementations, and embodiments have been described herein, it should be understood that the invention is not limited to any of the specific details provided.

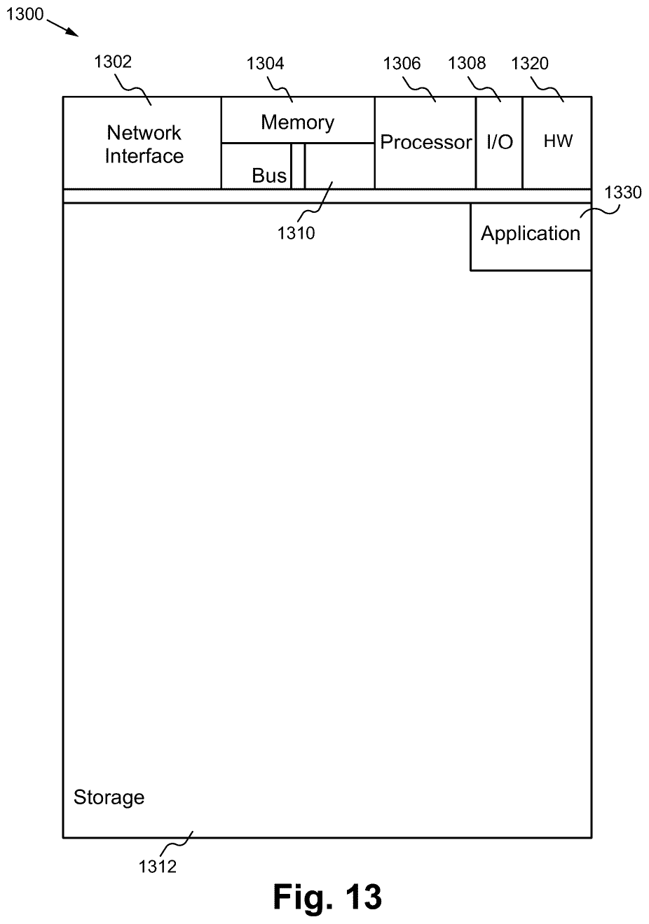

FIG. 13 shows a block diagram of an exemplary computing device configured to implement the LS signal generation method according to some embodiments. The computing device 1300 is able to be used to acquire, store, compute, process, communicate and/or display information. The computing device 1300 is able to implement any of the aspects of the method described herein. In general, a hardware structure suitable for implementing the computing device 1300 includes a network interface 1302, a memory 1304, a processor 1306, I/O device(s) 1308, a bus 1310 and a storage device 1312. The choice of processor is not critical as long as a suitable processor with sufficient computational capabilities is chosen. The memory 1304 is able to be any conventional computer memory known in the art. The storage device 1312 is able to include a hard drive, CDROM, CDRW, DVD, DVDRW, High Definition disc/drive, ultra-HD drive, flash memory card or any other storage device. The computing device 1300 is able to include one or more network interfaces 1302. An example of a network interface includes a network card connected to an Ethernet or other type of LAN. The I/O device(s) 1308 are able to include one or more of the following: keyboard, mouse, monitor, screen, printer, modem, touchscreen, button interface and other devices. LS signal generation application(s) 1330 used to implement the LS signal generation method are likely to be stored in the storage device 1312 and memory 1304 and processed as applications are typically processed. More or fewer components shown in FIG. 13 are able to be included in the computing device 1300. In some embodiments, LS signal generation hardware 1320 is included. Although the computing device 1300 in FIG. 13 includes applications 1330 and hardware 1320 for the LS signal generation method, the LS signal generation method is able to be implemented on a computing device in hardware, firmware, software or any combination thereof. For example, in some embodiments, the LS signal generation applications 1330 are programmed in a memory and executed using a processor. In another example, in some embodiments, the LS signal generation hardware 1320 is programmed hardware logic including gates specifically designed to implement the LS signal generation method. In some embodiments, the computing device has fewer or additional components.

In some embodiments, the LS signal generation application(s) 1330 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

In some embodiments, the LS signal is generated by a Digital Signal Processor (DSP), a Digital-to-Analog Converter (DAC), a Voltage-Controlled Oscillator (VCO), a Direct Digital Synthesizer (DDS) or a combination thereof. A frequency signal generator with chirp capabilities, a YIG oscillator, or an Arbitrary Waveform Generator (AWG) can also produce chirp signals. In some embodiments, the computing device includes one or more of these devices.

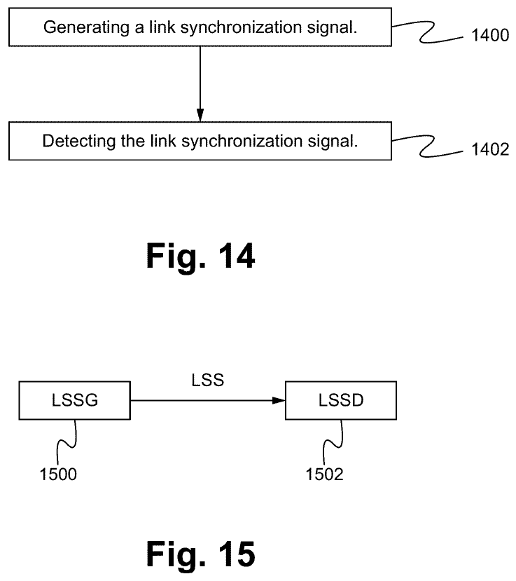

FIG. 14 shows a flowchart of an LS signal generation method according to some embodiments. In the step 1400, an LSS is generated by an LSSG. The link synchronization signal includes a binary chirp signal. The binary chirp signal is based on a plurality of counters. The binary chirp signal is defined based on a sign of a sinusoidal chirp signal. In some embodiments, generating the link synchronization signal involves wrapping values using rules of two's complement arithmetic. In some embodiments, generating the link synchronization signal involves scaling parameters so that all values are integers. In the step 1402, the LSS is detected by an LSSD. In some embodiments, fewer or additional steps are implemented. In some embodiments, the order of the steps is modified.

FIG. 15 shows a block diagram of a Link Synchronization Signal Generator (LSSG) and a Link Synchronization Signal Detector (LSSD) according to some embodiments. The LSSG 1500 generates the LSS as described herein. Specifically, the link synchronization signal includes a binary chirp signal. The LSS is communicated from the LSSG 1500 to the LSSD 1502 in any manner. For example, the LSS is communicated wirelessly or via a wire. The LSSD 1502 is able to detect the LSS in any manner. For example, the Matched Filter (MF) Impulse Response (IR) could be matched to one or several periods of the LSS Pseudo-Random Binary Sequence (PRBS), and the detector input signal could be filtered by a 510 taps FIR filter which is matched to one period of the LSS PRBS.

To utilize the LS signal generation method described herein, an LSSG generates a binary chirp signal which is able to be detected by an LSSD for link synchronization.

In operation, the LS signal function has the following advantage: it enables link synchronization function in the presence of the clock frequency offset in the range from −20% to 25% in the crystal-less mode of operation.

The chirp LS results in adding new LSSG and LSSD blocks to the PHY DSP part of the chip.

If another vendor used the proposed chirp LS function, that vendor's PHY's would be able to enable link synchronization function in the presence of the clock frequency offset in the range from −20% to 25% in the crystal-less mode of operation.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method comprising:
generating a link synchronization signal, wherein the link synchronization signal comprises a binary chirp signal; and
detecting the link synchronization signal in a crystal-less mode of operation.

2. The method of claim 1 wherein the link synchronization signal is generated using a link synchronization signal generator, and the link synchronization signal is detected using a link synchronization signal detector.

3. The method of claim 2 wherein the link synchronization signal generator comprises a plurality of counters.

4. The method of claim 3 wherein the plurality of counters comprise an output sample counter, an output period counter, a phase increment counter, and a phase counter.

5. The method of claim 1 wherein the binary chirp signal is based on a plurality of counters.

6. The method of claim 1 wherein the binary chirp signal is defined based on a sign of a sinusoidal chirp signal.

7. The method of claim 1 wherein generating the link synchronization signal involves wrapping values using rules of two's complement arithmetic.

8. The method of claim 1 wherein generating the link synchronization signal involves scaling parameters so that all values are integers.

9. An apparatus comprising:
a link synchronization signal generator configured for:
generating a link synchronization signal, wherein the link synchronization signal comprises a binary chirp signal; and
sending the link synchronization signal to a link synchronization signal detector in a crystal-less mode of operation.

10. The apparatus of claim 9 wherein the link synchronization signal is generated using a link synchronization signal generator, and the link synchronization signal is detected using a link synchronization signal detector.

11. The apparatus of claim 10 wherein the link synchronization signal generator comprises a plurality of counters.

12. The apparatus of claim 11 wherein the plurality of counters comprise an output sample counter, an output period counter, a phase increment counter, and a phase counter.

13. The apparatus of claim 9 wherein the binary chirp signal is based on a plurality of counters.

14. The apparatus of claim 9 wherein the binary chirp signal is defined based on a sign of a sinusoidal chirp signal.

15. The apparatus of claim 9 wherein generating the link synchronization signal involves wrapping values using rules of two's complement arithmetic.

16. The apparatus of claim 9 wherein generating the link synchronization signal involves scaling parameters so that all values are integers.

17. A system comprising:
a link synchronization signal generator configured for generating a link synchronization signal, wherein the link synchronization signal comprises a binary chirp signal; and
a link synchronization signal detector configured for detecting the link synchronization signal in a crystal-less mode of operation.

18. The system of claim 17 wherein the link synchronization signal is generated using a link synchronization signal generator, and the link synchronization signal is detected using a link synchronization signal detector.

19. The system of claim 18 wherein the link synchronization signal generator comprises a plurality of counters.

20. The system of claim 19 wherein the plurality of counters comprise an output sample counter, an output period counter, a phase increment counter, and a phase counter.

21. The system of claim 17 wherein the binary chirp signal is based on a plurality of counters.

22. The system of claim 17 wherein the binary chirp signal is defined based on a sign of a sinusoidal chirp signal.

23. The system of claim 17 wherein generating the link synchronization signal involves wrapping values using rules of two's complement arithmetic.

24. The system of claim 17 wherein generating the link synchronization signal involves scaling parameters so that all values are integers.
